(19) United States
(12) Patent Application Publication
(10) Pub. No.: US 2015/0271801 A1
(43) Pub. Date: Sep. 24, 2015

(54) WIRELESS COMMUNICATION APPARATUS AND METHOD, WIRELESS TERMINAL, MEMORY CARD, AND INTEGRATED CIRCUIT

(71) Applicant: KABUSHIKI KAISHA TOSHIBA, Tokyo (JP)

(72) Inventors: Ryoko MATSUO, Tokyo (JP); Tomoya TANDAI, Tokyo (JP); Tsuyoshi KOGAWA, Kawasaki Kanagawa (JP); Koji OGURA, Tachikawa Tokyo (JP); Tomoko ADACHI, Kawasaki Kanagawa (JP)

(73) Assignee: KABUSHIKI KAISHA TOSHIBA, Tokyo (JP)

(21) Appl. No.: 14/661,998

(22) Filed: Mar. 18, 2015

(30) Foreign Application Priority Data
Mar. 18, 2014 (JP) 2014-054630

(51) Int. Cl. H04W 72/04

(52) U.S. Cl. CPC H04W 72/0406; H04W 84/12

(57) ABSTRACT

According to one embodiment, a wireless communication apparatus using a first wireless communication scheme includes a transmitter and controller. The controller which controls IFSs so as to set, one of the first IFS and the second IFS as an IFS used during the first period. the controller sets the second IFS to at least a second period when a channel is idle during a period corresponding to a fourth IFS after one of the IFS is switched from the first IFS to the second IFS and when the channel becomes busy after the period corresponding to the fourth IFS is elapsed, the fourth IFS being an IFS before the transmission of a beacon signal, the second period being one of a plurality of first periods and being a period which includes timing for an estimated cycle of the beacon signal.

### CROSS-REFERENCE TO RELATED APPLICATIONS

This application is based upon and claims the benefit of priority from Japanese Patent Application No. 2014-054630, filed Mar. 18, 2014, the entire contents of which are incorporated herein by reference.

### FIELD

Embodiments described herein relate generally to a wireless communication apparatus and method, a wireless terminal, a memory card, and an integrated circuit.

### BACKGROUND

In the field of wireless communication, as a wireless system technique for high-rate transmission using millimeter waves, the development of the wireless HD standards and wireless local area network (LAN) IEEE 802.111ad standards have been completed.

From the viewpoint of increasing the rate of the frame transmission and reception, if a point-to-point close-proximity communication system is premised as a wireless system using millimeter waves, it is desirable to transmit and receive frames in short interframe spaces for a certain period of time after a connection is established. However, even in such a case, the coexistence of a wireless LAN system with other wireless systems in the same frequency band becomes a problem. As a procedure for allowing a close-proximity wireless system using millimeter waves to coexist with other wireless systems, there is a procedure of switching between a short interframe space and a long interframe space to transmit and receive frames on the wireless system using millimeter waves.

In a wireless LAN system, it is premised that access points (APs) transmits beacon signals at constant timings. Accordingly, if other wireless systems are wireless LAN systems, terminals other than APs can take synchronization with the APs by receiving beacon signals; as a result, the wireless systems can be maintained. In other words, beacon signals should be received at a certain level of frequency; otherwise, throughput of the system would be decreased, and it would be difficult to maintain the system.

In the above-described procedure of switching between different interframe spaces, beacon signal transmission and reception at a wireless LAN system are not considered. For this reason, if the timing of beacon signal transmission and reception falls within a transmission and reception interval of a short frame setting at a close-proximity wireless system, the transmission of beacon signals in the wireless LAN system will be, at maximum, shifted over the period which is set at the short interframe space. As a consequence, other wireless systems will be affected.

### BRIEF DESCRIPTION OF THE DRAWINGS

FIG. 1 is a conceptual drawing of a wireless system.

FIG. 2 is a block diagram showing a wireless communication apparatus according to the first embodiment.

FIG. 3 is a flowchart of the control operation of the interference controller according to the first embodiment.

FIG. 4 shows an example of a relationship between a close-proximity and short-range systems according to the first embodiment.

FIG. 5 is a flowchart showing the control operation of the interference controller according to the second embodiment.

FIG. 6 shows an example of the relationship between the close-proximity and short-range systems according to the second embodiment.

FIG. 7 shows another example of the relationship between the close-proximity and short-range systems according to the second embodiment.

FIG. 8 shows an example of a method of verifying estimated beacon timings.

FIG. 9 shows an example of the relationship between the close-proximity and short-range systems in a case where the beacon interval is 50 ms (millisecond).

FIG. 10 shows an example of the relationship between the close-proximity and short-range systems in a case where the beacon interval is 25 ms.

FIG. 11 is a block diagram showing a wireless communication apparatus according to the fifth embodiment.

FIG. 12 is a block diagram showing a wireless communication apparatus according to the sixth embodiment.

FIG. 13 is a block diagram showing a wireless communication apparatus according to the seventh embodiment.

FIG. 14 is a block diagram showing a wireless communication apparatus according to the eighth embodiment.

FIG. 15 is a block diagram showing a wireless communication apparatus according to the ninth embodiment.

FIG. 16 is a block diagram showing a wireless communication apparatus according to the tenth embodiment.

FIG. 17 is a block diagram showing a wireless communication apparatus according to the eleventh embodiment.

FIG. 18 is a block diagram showing a wireless communication apparatus according to the twelfth embodiment.

FIG. 19 is a block diagram showing a wireless communication apparatus according to the thirteenth embodiment.

FIG. 20 is a block diagram showing a wireless communication apparatus according to the fourteenth embodiment.

FIG. 21 is a block diagram showing a wireless communication apparatus according to the fifteenth embodiment.

FIG. 22 is a block diagram showing a hardware configuration of a wireless communication apparatus equipped with a wireless terminal.

FIG. 23 is a perspective view of a wireless apparatus according to the seventeenth embodiment.

FIG. 24 shows an example of a case where a wireless communication apparatus is equipped with a memory card.

### DETAILED DESCRIPTION

In general, according to one embodiment, a wireless communication apparatus using a first wireless communication scheme includes a transmitter and controller. the transmitter transmits a frame using one of a first interframe space (IFS) and a second IFS, the first IFS being shorter than a third IFS which is used in a second wireless communication scheme having a coverage area wider than a coverage area of the first wireless communication scheme, the second IFS being longer than the third IFS. The controller which controls IFSs so as to set, for each first period, one of the first IFS and the second IFS as an IFS used during the first period. When a channel is idle during a period corresponding to a fourth IFS after one of the IFSs is switched from the first IFS to the second IFS, and when the channel becomes busy after the period corresponding to the fourth IFS is elapsed, the controller sets the second IFS to at least a second period, the fourth IFS being an IFS before the transmission of a beacon signal used in the second wireless communication scheme, the second period being one of a plurality of first periods and being a period which includes timing for an estimated cycle of the beacon signal.

In the following, the wireless communication apparatus and method, the wireless terminal, and the memory card according to one of the embodiments of the present disclosure will be described in detail with reference to the drawings. In the embodiment described below, elements specified by the same reference numbers carry out the same operations, and a duplicate description of such elements will be omitted.

In the present embodiment, a wireless system on a wireless communication scheme that uses a communication range of at the widest a few tens of centimeters is called a close-proximity system. Other wireless systems on a wireless communication scheme that uses a communication range wider than that of the close-proximity system, such as IEEE802.11 which uses the communication range of a few tens of meters, are called a short-range system.

### First Embodiment

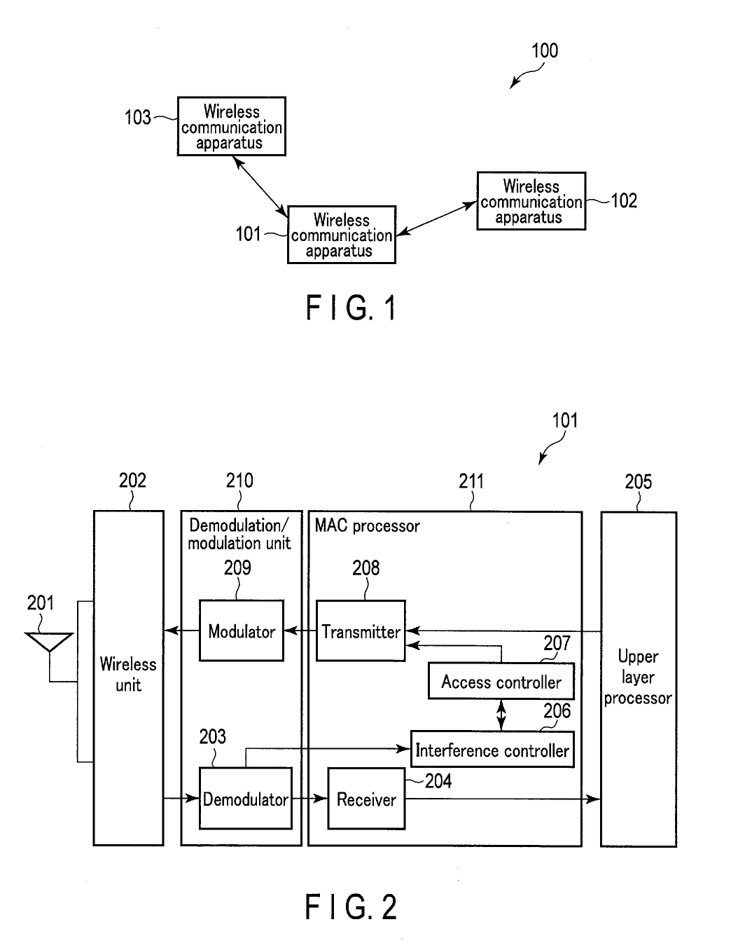

A conceptual drawing of a close-proximity system according to the present embodiment will be explained with reference to FIG. 1.

A close-proximity system 100 includes a wireless communication apparatus 101, a wireless communication apparatus 102, and a wireless communication apparatus 103.

In the close-proximity system 100 according to the present embodiment, a few tens of centimeters at the widest is assumed for the communication range of each of the wireless communication apparatuses 101, 102, and 103. Thus, a procedure more effective than a conventional procedure that emphasizes interference avoidance and the fairness of wireless bandwidths in a wireless local network (LAN), for example, a procedure including transmitting broadcast signals (e.g., beacon signals) from a device acting as an access point (AP) and performing random back-off by a different device, is anticipated.

As an effective procedure, when performing signal transmission, random back-off control is carried out to transmit and receive a control signal to initiate a connection, such as a connection request signal, among the wireless communication apparatuses 101, 102, and 103. After a connection is established, it is possible to adopt a procedure wherein an interframe space shorter than a different interframe space in other wireless systems (e.g., IEEE802.11) is set as an interframe space to be used first, and frame transmission is performed consecutively without performing carrier sensing, and then an interframe space is adjusted.

As the configuration of the wireless communication apparatuses 101, 102, and 103 is similar to each other, primarily the wireless communication apparatus 101 will be explained. In the example shown in FIG. 1, there are three wireless communication apparatuses (101 to 103); however, more wireless communication apparatuses can exist in the system.

Next, the wireless communication apparatus according to the first embodiment will be explained with reference to the block diagram of FIG. 2.

The wireless communication apparatus 101 according to the first embodiment includes an antenna 201, a wireless unit 202, a demodulator 203, a receiver 204, an upper layer processor 205, an interference controller 206, an access controller 207, a transmitter 208, and a modulator 209. The demodulator 203 and the modulator 209 together may be referred to as a demodulation/modulation unit 210. The receiver 204, the interference controller 206, the access controller 207, and the transmitter 208 all together may be referred to as a MAC (Media Access Control) processor 211.

The antenna 201 is an antenna with a common configuration, and it receives signals from outside of the apparatus. The antenna 201 receives transmitted signals from the wireless unit 202 (will be described later) to transmit signals to the outside of the apparatus. It would be possible to reduce a foot-print if the wireless communication apparatus 101 is configured to include the antenna 201 to constitute one apparatus as a whole. The transmission process and the reception process share the antenna 201. This makes it possible to reduce the size of the wireless communication apparatus 101.

The wireless unit 202 receives a received signal from the antenna 201, performs frequency conversion on the received signal to convert it into a baseband signal, and performs analog-to-digital (AD) conversion on the frequency-converted signal to generate a received digital signal. The wireless unit 202 receives a transmitted digital signal from a demodulator 209 (will be described later), performs digital-to-analog conversion (DA conversion), and performs frequency conversion on the converted signal (i.e., a baseband signal) into a wireless frequency band to be used to generate a transmission signal.

The demodulator 203 receives the received digital signal from the wireless unit 202, performs a demodulation process on the received digital signal, and performs processing, such as a physical header analysis, to generate a demodulated frame. The demodulator 203 also performs carrier sensing on a channel in use to determine whether the channel is idle or busy. An idle status means that there is no signal received from another apparatus and the channel is empty. A busy status means that signals are received from another apparatus and the channel is occupied. The determination result is obtained as a carrier sensing result (CCA; Clear Channel Assessment).

The receiver 204 receives the demodulated frame from the demodulator 203, and performs an analysis on a MAC header, etc., to determine whether or not the demodulated frame is a frame transmitted from the other end of the communication. If the demodulated frame is a frame transmitted from the other end of the communication, the demodulated frame is transmitted to the upper layer processor 205.

The upper layer processor 205 receives the demodulated frame from the receiver 204, and performs data processing on the demodulated frame by an upper layer application. The upper processor 205 generates data to be transmitted to the communication recipient.

The interference controller 206 maintains information related to an interframe space (IFS) adjustment period (may be referred to as a first period) and periods set as a BIFS (Basic IFS, also referred to as a first IFS) and a LIFS (Long IFS, also referred to as a second IFS). An IFS adjustment period is a unit of a period in which an interframe space setting is switched. A BIFS is an interframe space shorter than a different type of interframe space (also referred to as a third IFS) in other wireless systems (a short-range system). A LIFS is an interframe space longer than a different type of interframe space of other wireless systems (a short-range system).

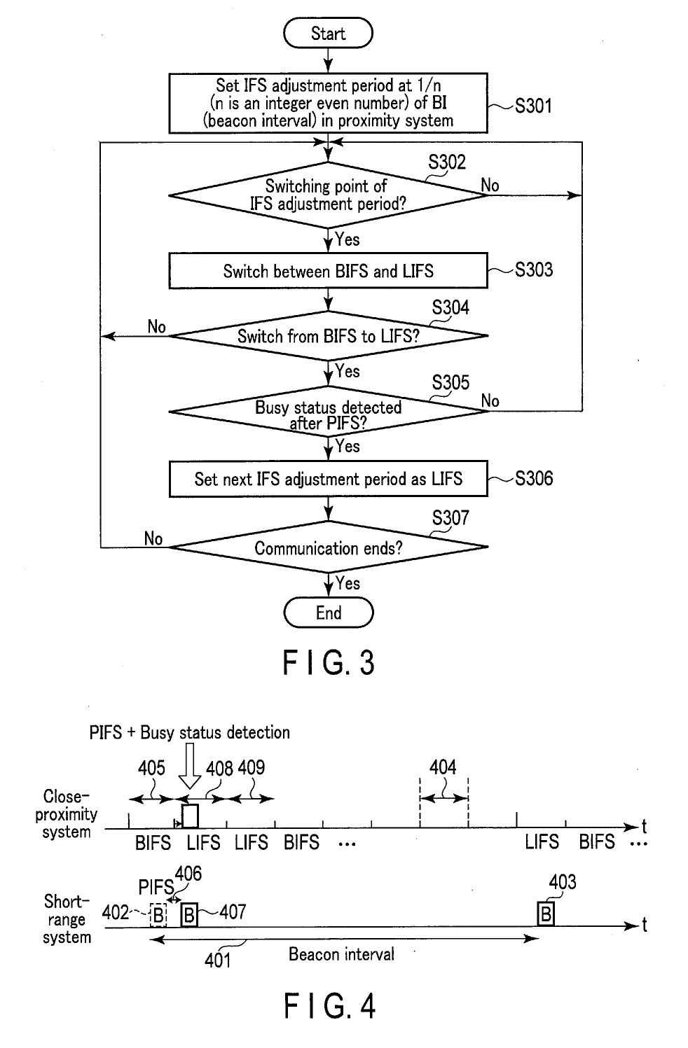

The interference controller 206 receives a CCA from the demodulator 203, and generates a notification for the IFS switching between a BIFS and a LIFS. To generate the notification, an idle period during which a channel is at idle is taken into consideration, referring to the received CCA. The notification for the IFS switching may be, for example, an instruction to measure a predetermined length of time with a timer, etc. and to switch from an interframe space to another when the predetermined length of time is elapsed. The details of the control process at the interference controller 206 will be described later with reference to FIG. 3.

The access controller 207 receives the CCA and the IFS switching notification from the interference controller 206. For example, if the CCA indicates idle, the Access controller 207 sends a transmission instruction to the transmitter 208 to set the interframe space as a BIFS or a LIFS in accordance with the switching notification.

The transmitter 208 receives data from the upper layer processor 205, and accumulates the received data at a transmission buffer. After performing a process of adding an MAC header, etc. on the frames in the order of accumulation, the transmitter 208 generates a transmission frame when the transmission instruction is received from the access controller 207.

The demodulator 209 receives the transmission frame from the transmitter 208, performs physical layer-related processing on the transmission frame such as encoding, modulation, and adding physical headers, etc., to generate a transmit digital signal.

Next, control processing by the interference controller 206 according to the first embodiment will be explained with reference to the flowchart shown in FIG. 3.

At step 5301, the interference controller 206 sets the IFS adjustment period at 1/n of the beacon interval (BI) of the short-range system. The 1/n represents a fraction, and n is a positive even number. The beacon interval is an interval of transmitting beacon signals. In the first embodiment, a predetermined value is set for the beacon interval of the short-range system, and the IFS adjustment period is set at 1/n of the predetermined value.

At step S302, the interference controller 206 determines whether the IFS adjustment period is finished and whether or not it is time for switching the IFS adjustment period. In other words, the timer starts counting since the beginning of the IFS adjustment period, and when the timer exceeds a predetermined length of time, it is determined that it is a time for switching the IFS adjustment period or not. If it is the time for switching the IFS adjustment period, the process proceeds to step S303. If it is not the time for switching the IFS adjustment period, the process returns to step S302, and repeats the same processing.

At step 5303, the interference controller 206 notifies the access controller 207 of a switching notification so that the IFS is switched to the IFS different from the IFS that was set before the switching timing. In other words, a BIFS and a LIFS alternate for each IFS adjustment period, a BIFS before the switching timing is switched to a LIFS after the switching timing, and a LIFS before the switching timing is switched to a BIFS after the switching timing. The IFS adjustment period is set in this manner in order to achieve a balance of the transmission and reception opportunities between the short-range system and the close-proximity system.

At step S304, the interference controller 206 determines whether or not the switching at step S303 is a switch from a BIFS to a LIFS. If the switching is a switch from a BIFS to a LIFS, the process proceeds to step S305; if not, the process returns to step S302, and repeats the same processing.

At step S305, the interference controller 206 switches the interframe space from a BIFS to a LIFS, then determines whether or not a busy status of a channel is detected after a PIFS [PCF (Point Coordinator Function) IFS, also referred to as a fourth IFS] period elapses. PIFS is an interframe space shorter than an interframe space of a different frame in the short-range system, and it is used for transmitting a beacon signal prior to other signals. Specifically, in IEEE802.11ad using millimeter waves, for example, the length of PIFS is about 8 μs; however, the frequency and standards are not limited thereto. When a busy status is detected after the PIFS period is elapsed, it is assumed that the short-range system was at beacon timing which is timing for transmitting a beacon signal when the IFS adjustment period was a BIFS. In this case, the process proceeds to step S306. If no busy status is detected after the PIFS period is elapsed, the process returns to step S302, and repeats the same processing.

At step S306, the interference controller 206 sets a LIFS in the next IFS adjustment period so that the order of BIFSs and LIFSs is reversed. Since the IFS adjustment period is 1/n of a beacon interval, it is possible to set an IFS adjustment period at the next beacon timing as a LIFS by setting the next IFS adjustment period as a LIFS when a busy status is detected after the PIFS period has elapsed after an interframe space is set as a LIFS.

At step S307, it is determined whether or not a communication is finished. If finished, the process is finished. If not, the process proceeds to step S302 and continues the process at step S302 through step S307. Thus, the control process of the interference controller 206 is ended.

FIG. 4 shows an example of the relationship between the IFS adjustment in the close-proximity system and the beacon signals in the short-range system according to the first embodiment.

The upper drawing in FIG. 4 indicates a communication in the close-proximity system including the wireless communication apparatus according to the first embodiment, and the lower drawing in FIG. 4 indicates a communication in the short-range system.

In the example illustrated in FIG. 4, a wireless LAN is assumed as the short-range system. A beacon interval 401 of the AP in the short-range system is an interval between beacon timing 402 and beacon timing 403. A beacon signal is transmitted (broadcast) for every beacon interval 401. As the beacon interval 401, for example, 100 ms is set as a recommended value. A beacon signal is transmitted and received using PIFS so that a beacon signal is transmitted prior to other frames.

On the other hand, in the close-proximity system including the wireless communication apparatus 101 according to the first embodiment, 1/n of a beacon interval is set as an IFS adjustment period 404, and a BIFS and a LIFS alternate for each IFS adjustment period. Herein, as an example, one eighth of a beacon interval is set as an IFS adjustment period. Suppose the wireless communication apparatuses in the close-proximity system perform burst transmission to each other during the IFS adjustment period 405 to transmit data consecutively at a predetermined interval.

During the burst transmission in the close-proximity system, the AP in the short-range system cannot have a transmission opportunity as a result of performing carrier sensing because a busy channel period continues, and the AP cannot transmit beacon signals even when the beacon timing 402 arrives. Therefore, the AP, which plans to transmit a beacon signal at the beacon timing 402, waits for the transmission until the channel will be idle for a period longer than PIFS. The AP in the short-range system performs carrier sensing after the PIFS 406 has elapsed since the beacon timing 402, and confirms if the channel will be idle longer than PIFS to transmit a beacon signal (beacon timing 407). It should be noted that the beacon timing 403 for transmitting the next beacon signal should arrive after the beacon interval 401 with the beacon timing 402 for transmitting an originally-planned beacon signal as a starting point.

On the other hand, after the burst transmission in the IFS adjustment period 405 is finished, the wireless communication apparatus 101 in the close-proximity system estimates whether or not the AP in the short-range system transmits a beacon signal during the next IFS adjustment period 401 after the interframe space is switched from a BIFS to a LIFS. If a channel is idle during a period corresponding to PIFS after switching from a BIFS to a LIFS, and the channel becomes busy later, the wireless communication apparatus 101 can estimate that the short-range system reaches beacon timing during a BIFS, and that a transmission timing of a beacon signal shifts from a planned timing due to the failure in the beacon signal transmission.

Therefore, the wireless communication apparatus 101 sets the next IFS adjustment period 409 as a LIFS when a busy status is observed after the PIFS period 406, and sets a LIFS and a BIFS alternately for each IFS adjustment period. As a result, it is possible to set the IFS adjustment period in the close-proximity system as a LIFS at the beacon timing 403 when a next beacon signal is transmitted.

It should be noted that there may be, in reality, a case where the timing of switching an interframe space from a BIFS to a LIFS for each IFS adjustment period does not match the timing of when data frame transmission and response frame reception are finished. In this case, the point of time when transmission and reception of a data frame and ACK response frame for the last time before switching the interframe space from a BIFS to a LIFS can be used as a starting point timing to determine whether or not a channel is idle during a PIFS period.

For example, if a data frame is being transmitted at a timing when the interframe space is switched from a BIFS to a LIFS, the point of time when reception of an ACK response frame in response to a data frame is finished is adopted as the starting point timing. Beacon timing can be determined from this starting point timing depending on whether or not a channel becomes busy after being idle during PIFS. This is how to improve accuracy in estimating beacon timing.

According to the first embodiment described above, if a channel is first idle during PIFS and then busy after the interframe space of the IFS adjustment period is switched from a BIFS to a LIFS, it is estimated that there is beacon timing of the short-range system during a BIFS before the switching. In a case where a BIFS and a LIFS are set alternately by setting two IFS adjustment periods as a LIFS in a row, the IFS adjustment period corresponding to beacon timing can be set as a LIFS. Thus, it is possible to balance the transmission and reception opportunities between the close-proximity system and the short-range system and to achieve coexistence of the close-proximity system with the short-range system, reducing the influence on the beacon signal transmission in the short-range system.

### Second Embodiment

In the first embodiment, the beacon timing in the short-range system is taken into consideration, and the ratio of a BIFS to a LIFS is set to be 1 to 1 to achieve an equal balance of transmission and reception opportunities between the short-range system and the close-proximity system. However, there may be the case where the only interference between the close-proximity system and the short-range system comes from beacon signals; in other words, no data frame may be transmitted or received in the short-range system. Thus, if the channel share of the short-range system is originally low, throughput of the close-proximity system may be needlessly lowered when a BIFS and a LIFS are repeated alternately in a predetermined period of time.

Accordingly, in the second embodiment, an IFS adjustment period, which is estimated as being beacon timing, at least is set as a LIFS, thereby flexibly achieving coexistence of the close-proximity system with the short-range system, without reducing throughput of the close-proximity system.

As the wireless communication apparatus according to the second embodiment is the same as that of the first embodiment, the explanation with reference to the block diagrams will be omitted.

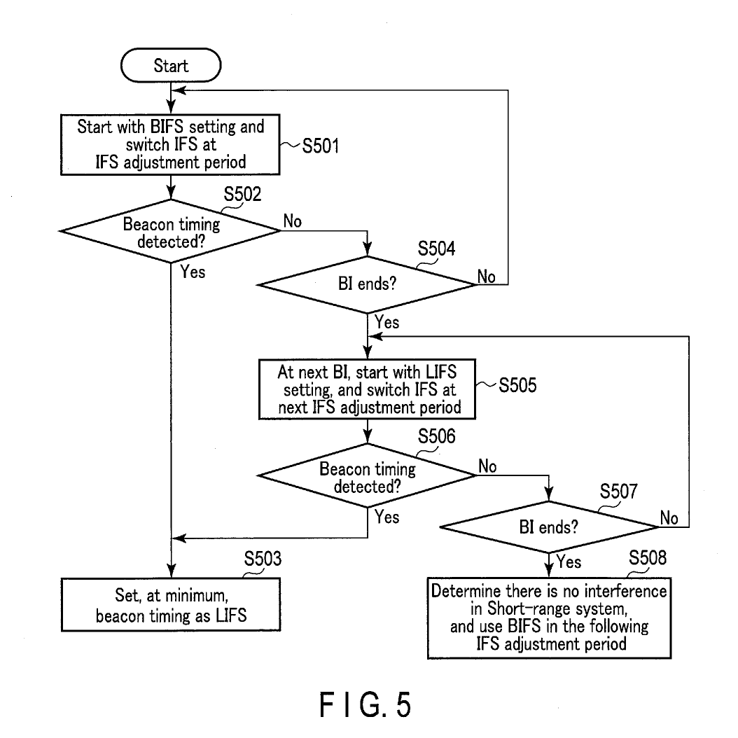

The control process of the interference controller 206 according to the second embodiment will be explained with reference to the flowchart of FIG. 5.

At step S501, the interframe space of the IFS adjustment period begins with a BIFS, and the interframe space switches between a BIFS and a LIFS for each IFS adjustment period over a beacon interval of the short-range system.

At step S502, it is determined whether or not beacon timing is detected. Beacon timing can be estimated by the control processing executed by the interference controller 206 described in the first embodiment. If beacon timing is detected, the process proceeds to step S503; if not, the process proceeds to step S504.

At step S503, if beacon timing is detected, the beacon timing thereafter can be estimated from the beacon interval. Thus, the interframe space of the IFS adjustment periods corresponding to at least subsequent beacon timing is set as a LIFS. Other timing can be set freely.

At step S504, it is determined whether or not one cycle of the beacon interval is finished. If one cycle of the beacon interval is finished, the process proceeds to step S505; if not, the process returns to step S501, and repeats the same processes.

At step S505, at the next beacon interval the first IFS adjustment period is set as a LIFS, and the interframe space is switched between a BIFS and a LIFS every IFS adjustment period.

At step S506, it is determined whether or not beacon timing is detected. If beacon timing is detected, the process proceeds to step S503; if not, the process proceeds to step S507.

At step S507, it is determined whether or not one cycle of the beacon interval is finished. If one cycle of the beacon interval is finished, the process proceeds to step S508; if not, the process returns to step S505 and repeats the same process.

At step S508, it is determined that there is no interference of the short-range system because no beacon timing can be detected in two cycles of the beacon interval, and the interframe space of the IFS adjustment period thereafter can be set as a BIFS. Thus, the close-proximity system can prioritize transmitting and receiving data. The control process of the interference controller 206 according to the second embodiment can be finished.

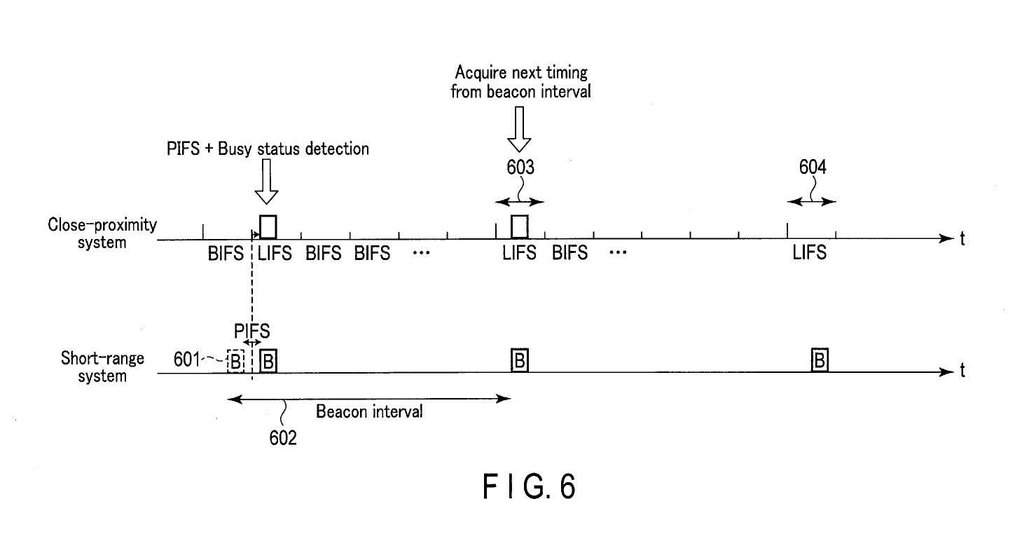

Next, an example of the relationship between the IFS adjustment in the close-proximity system according to the second embodiment and beacon signals in the short-range system according to the second embodiment will be explained with reference to FIG. 6.

In the close-proximity system shown in FIG. 6, in the IFS adjustment period, a busy status is detected after the PIFS period is elapsed after the interframe space is switched from a BIFS to a LIFS; thus, it is assumed that beacon timing 601 of the short-range system in the IFS adjustment period is present before the switching. Thus, after beacon timing is detected, the interframe space is set at a LIFS, assuming that beacon timing exists in the IFS adjustment period 603 and IFS adjustment period 604 corresponding to the period after the beacon interval 602. It should be noted that an interframe space can be set as a BIFS only, or can be switched between a BIFS and a LIFS in a period other than the period corresponding to beacon timing.

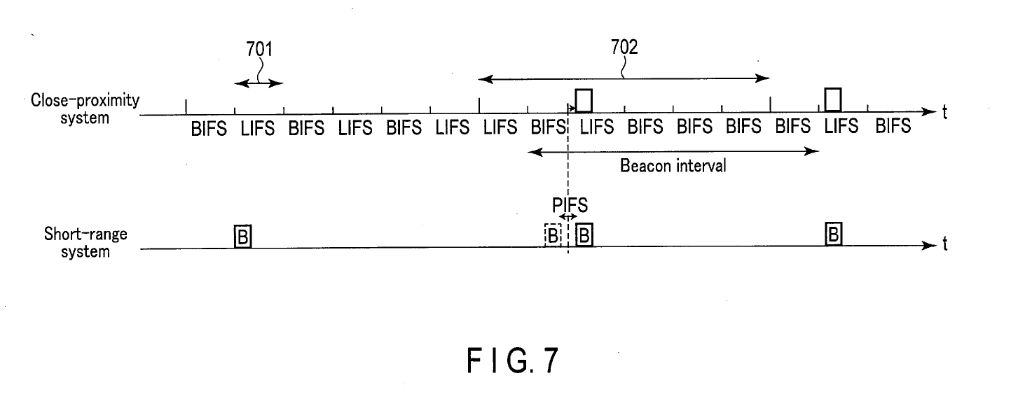

Next, another example of the relationship between the IFS adjustment in the close-proximity system and the beacon signal in the short-range system is shown in FIG. 7. As shown in FIG. 7, there may be a case where no beacon timing can be detected over a few consecutive beacon intervals. For example, when the interframe space of the IFS adjustment period is set as a LIFS at the close-proximity system, a beacon timing happens to be transmitted (IFS adjustment period 701). In this case, the period corresponding to the next beacon period 702 is set in the reversed order of BIFSs and LIFSs. For example, if the interframe space is set in the order of BIFS, LIFS, BIFS, . . , in the period corresponding to the beacon interval before the period 702, the interframe space is set in the order of LIFS, BIFS, LIFS, . . . in the period 702.

Thus, compared to the previous cycles where no beacon timing can be detected, the possibility of an arrival of beacon timing is increased when the interframe space of the IFS adjustment period is set as a BIFS, and beacon timing can be detected.

It is possible to verify if the estimated beacon timing is correct or not by the process of detecting the beacon timing.

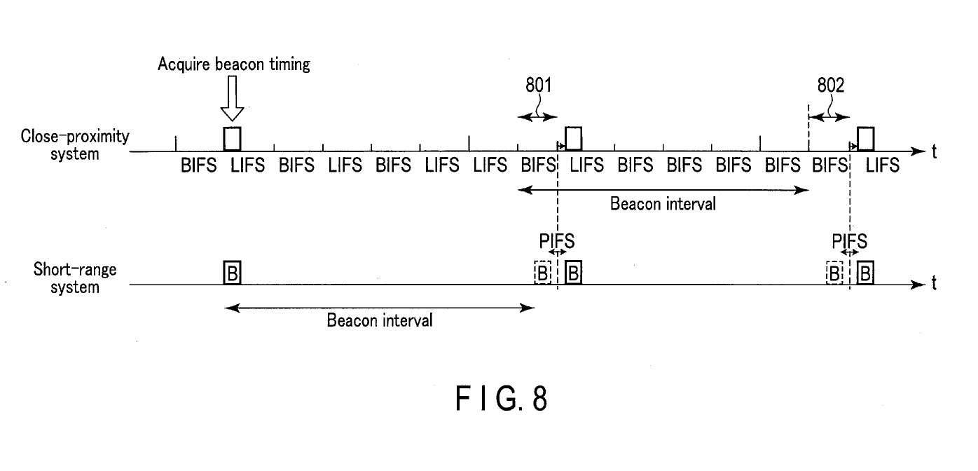

The method of verifying the estimated beacon timing will be explained with reference to FIG. 8.

As shown in FIG. 8, after beacon timing is detected, the interframe space of each of the IFS adjustment period 801 and the adjustment period 802 is set as a BIFS at the timing corresponding to timing at a predicted beacon interval. Thus, if a BIFS setting is changed to a LIFS setting, and a busy status is detected after a PIFS period is elapsed, it can be estimated that a beacon signal is transmitted. Thus, it is possible to determine if the estimated beacon interval and the estimated beacon timing are correct. Afterwards, the interframe space of the IFS adjustment period corresponding at least to beacon timing is set as a LIFS, as shown in FIGS. 6 and 7.

According to the second embodiment described above, beacon timing is detected, and at least the short-range system sets the IFS adjustment period, which is estimated as beacon timing, as a LIFS. Thus, it is possible to achieve coexistence of the close-proximity system and the short-range system flexibly without reducing throughput of the close-proximity system, and to avoid influencing the beacon transmission at the short-range system, in accordance with the extent of interference and the channel occupancy status of the short-range system.

### Third Embodiment

In the above-described embodiments, the processing is carried out on the assumption that the beacon interval of the short-range system is a recommended value, i.e., 100 ms; in contrast, a case where the beacon interval is not 100 ms is assumed in the third embodiment. Thus, even when the beacon interval is unknown, beacon timing can be estimated in a manner similar to the first and second embodiments; thus, the coexistence of the close-proximity system with the short-range system can be achieved.

As the wireless communication apparatus according to the third embodiment is the same as that of the first embodiment, the explanation with reference to the block diagram will be omitted.

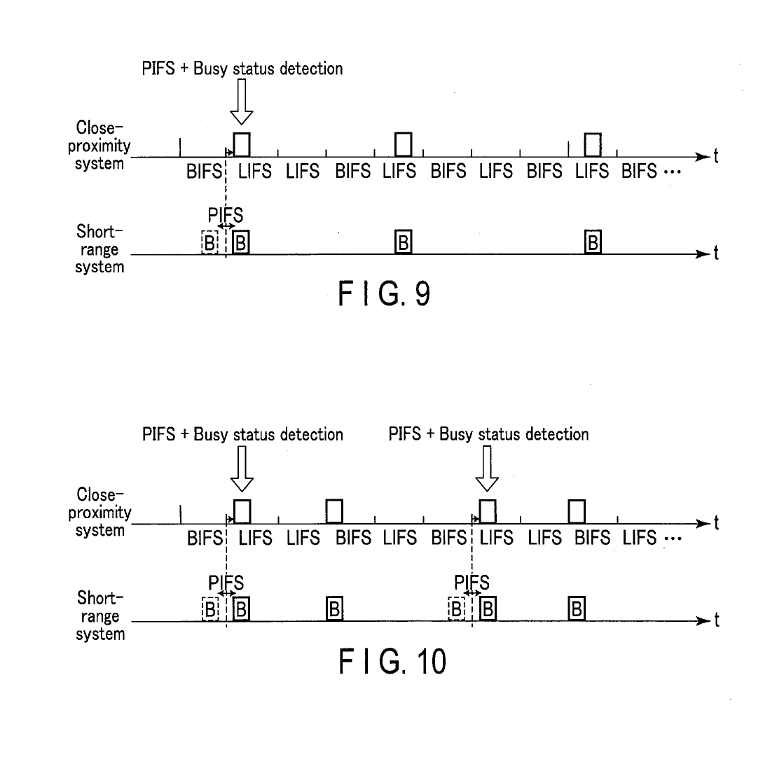

The process of detecting beacon timing according to the third embodiment will be explained with reference to FIG. 9 and FIG. 10.

FIG. 9 shows the relationship between the close-proximity system and the short-range system in a case where the beacon interval is 50 ms, and FIG. 10 shows the relationship between the close-proximity system and the short-range system in a case where the beacon interval is 25 ms. Herein, it is assumed that the beacon interval of the short-range system assumed in the close-proximity system is 100 ms.

In a case where the beacon interval is 50 ms as shown in FIG. 9, the beacon timing does not overlap the period which is set as a LIFS in the IFS adjustment period even if the control processing of the interference controller 206 according to the first or second embodiments is adopted; thus, beacon timing can be mostly detected.

On the other hand, in a case where the beacon interval is 25 ms as shown in FIG. 10, even if beacon timing is first detected and the beacon adjustment period after 100 ms is set as a LIFS, timing when a busy status is detected after the PIFS period is elapsed appears three times during an estimated beacon interval of 100 ms after the interframe space is switched again from a BIFS to a LIFS, because the actual beacon interval is 25 ms.

In such a case, assuming that the beacon interval is shorter than 100 ms, a busy status cycle can be estimated by continuously detecting timing of a busy status of the short-range system after the PIFS period is elapsed. Thus, the beacon interval is updated in accordance with an estimated cycle, and the interframe space is set as a LIFS for each IFS adjustment period corresponding to beacon timing based on the updated beacon interval.

According to the third embodiment described above, even if the estimated beacon interval is different from the actual beacon interval, it is possible to estimate which IFS adjustment period should next be set as a LIFS by detecting a busy status cycle after the PIFS period is elapsed. Thus, coexistence of the close-proximity system with the short-range system can be achieved, decreasing the influence on the beacon transmission in the short-range system.

### Fourth Embodiment

It is possible to configure by design choice an AP and a terminal having a function equivalent to an AP in a short-range system to transmit frames other than beacons during a PIFS period. Accordingly, if a busy status after the PIFS period has elapsed is frequently detected after setting an interframe space as a LIFS, it is necessary to distinguish the beacon signals from other signals. In the fourth embodiment, in case a busy status after the PIFS period has elapsed is frequently detected after setting an interframe space as a LIFS, the process of determining whether or not a detected busy status is due to a beacon signal will be explained below.

As the wireless communication apparatus according to the fourth embodiment is the same as that of the first embodiment, the explanation with reference to the block diagram will be omitted.

As a first example of the determination process, a time during which a busy status continues is measured when it is detected that a busy status of the system after the

PIFS period has elapsed. If the continuous time of the busy status is almost equal to a period corresponding to a frame of the beacon signal, it can be determined that the measured busy status is due to a beacon signal transmitted from the short-range system. On the other hand, if the continuous time of the busy status is longer than a period corresponding to a frame of the beacon signal, it can be determined that the busy status after the PIFS period is due to a signal other than a beacon signal.

As a second example of the determination process, it is determined whether or not the channel is idle only during SIFS (short IFS) when the busy status after the PIFS period is ended and a busy status is detected immediately again. If a busy status can be detected again after the SIFS period, it can be assumed that a response signal is transmitted after the SIFS period. Accordingly, it can be determined that the busy status after the PIFS period is a signal requesting for a response signal, in other words, a signal other than a beacon signal.

As a third example of the determination process, suppose, for example, a short-range system uses millimeter waves under IEEE 802.11ad standards. Under IEEE 802.11ad standards, a period called BTI (Beacon Transmission Interval) is set immediately after transmitting a beacon signal, and a signal called DMG (Directional Multi Gigabit) beacon can be transmitted for each sector by an AP of a short-range system. Thus, when the busy status after the PIFS period has ended, it is determined whether or not the system will be in a busy status during the BTI period. If the system is busy during the BTI period, it can be assumed that a DMG beacon was transmitted; thus, it can be determined that the busy status after the PIFS period is due to a beacon signal.

As a fourth example of the determination process, like the third example, if the short-range system is compliant with IEEE 802.11ad, an AP in the short-range system transmits beacon signals omni-directionally, and beam forming is presumed for the data transmission and reception with each station (STA) other than beacon signals. Thus, a determination can be made according to whether or not a difference between a reception power during a busy period after the PIFS period and a reception power during another busy period is greater than a threshold. For example, if the reception power difference is lower than a threshold, the reception power is the same as the reception power of the signal in other busy periods. Accordingly, it can be determined that the signal that makes the system busy after the PIFS signal period is a signal other than a beacon signal.

According to the fourth embodiment described above, it is possible to set an IFS adjustment period as a LIFS in accordance with a timing which is estimated as beacon timing by estimating which signal is a beacon signal, even when signals other than beacon signals are transmitted at PIFS in the short-range system. Thus, it is possible to estimate beacon timing more appropriately, and coexistence of the close-proximity system with the short-range system can be achieved, reducing the influence on the beacon signal transmission in the short-range system.

It should be noted that each process described in the first through fourth embodiments is a process at a device in which a close-proximity system is implemented in a case where there is a device carrying out transmission and reception implemented in a short-range system. However, there is a possibility that both of a close-proximity system and a short-range system are implemented in the same device. For example, if it is possible to transmit and receive control signals between two systems implemented on one device, a short-range system acquires beacon timing information and sends it to a close-proximity system, and the close-proximity system waits for the transmission so that beacon signal transmission can be prioritized. However, in order to achieve such a configuration, a communication of control signals between two systems is required.

On the other hand, in a general case where multiple systems are implemented in one device, it would be easier to achieve such an implementation if the communication of control signals among multiple systems is unnecessary. Accordingly, even if two systems are implemented in one device, it is possible to carry out the processes similar to those of the first to fourth embodiments in a close-proximity system, thereby estimating beacon timing in a short-range system.

### Fifth Embodiment

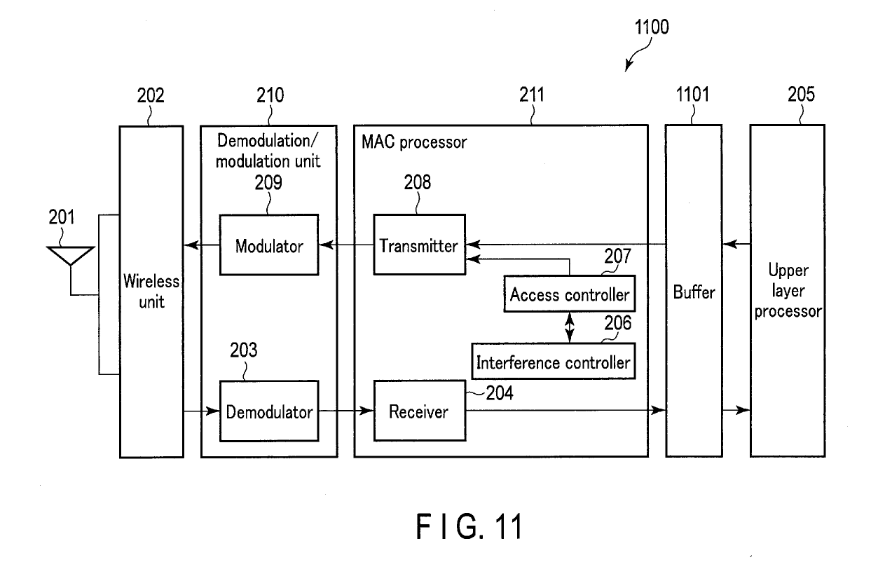

The wireless communication apparatus according to the Fifth embodiment will be explained with reference to the block diagram of FIG. 11.

The wireless communication apparatus 1100 according to the fifth embodiment includes a buffer 1101 in addition to the wireless communication apparatus 101 shown in FIG. 2. The buffer 1101 is connected to the transmitter 208, the receiver 204, and the upper layer processor 205, and it may be provided between the transmitter 208, the receiver 204, and the upper layer processor 205, or inside of the upper layer processor 205. This structure allows the buffer to store transmitted data and received data, and thus, retransmission or external output processing easily can be easily realized.

### Sixth Embodiment

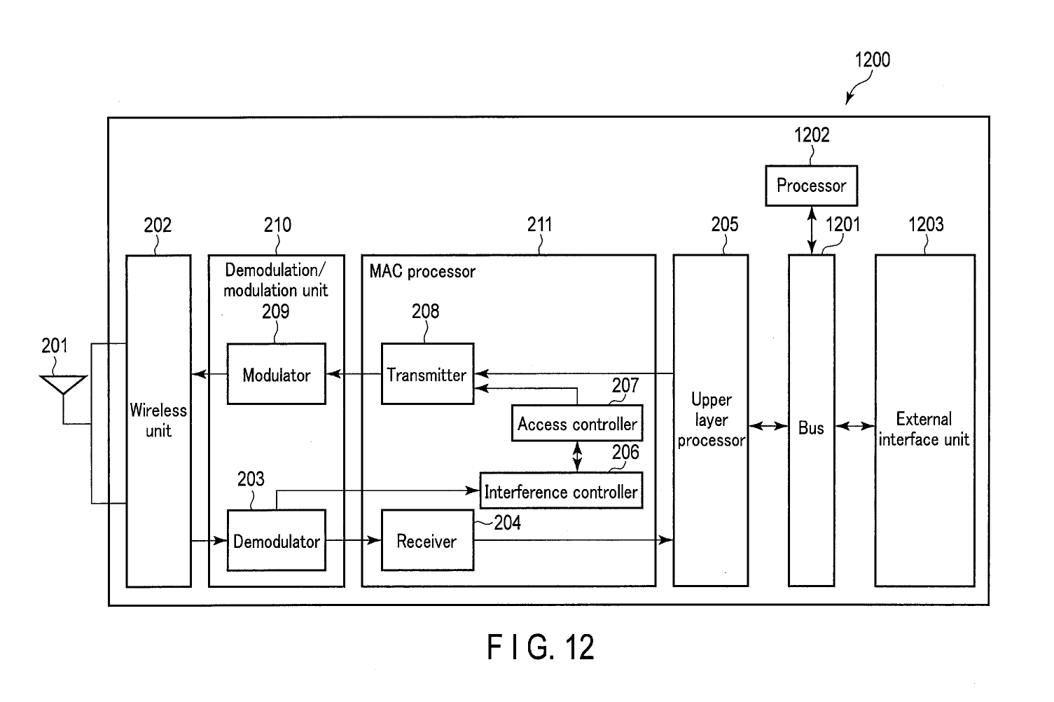

The wireless communication apparatus according to the sixth embodiment will be explained with reference to the block diagram of FIG. 12.

The wireless communication apparatus 1200 according to the sixth embodiment includes a bus 1201, a processor 1202, and an external interface unit 1203 in addition to the wireless communication apparatus 101 shown in FIG. 2. The processor 1202 and the external interface unit 1203 are connected to the upper layer processor 205 via the bus 1201. The processor 1202 and the external interface unit 1203 may be provided inside the upper layer processor 205, or may exist independently. Firmware operates in the processor 1202. Such a wireless communication apparatus which includes the firmware can change the functions easily by rewriting the firmware.

### Seventh Embodiment

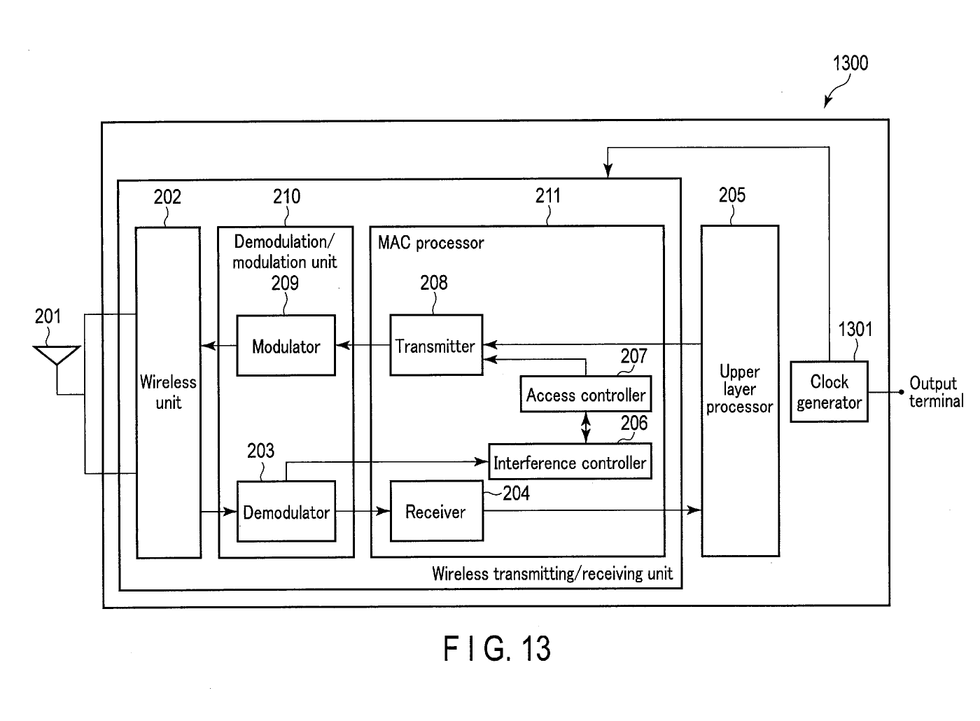

The wireless communication apparatus according to the seventh embodiment will be explained with reference to the block diagram of FIG. 13.

The wireless communication apparatus 1300 according to the seventh embodiment includes a clock generation unit 1301 in addition to the wireless communication apparatus 101 shown in FIG. 2. If the MAC processor 211, the demodulation/modulation unit 210, and the wireless unit 202 are referred to as a wireless transmitting and receiver as a whole, the clock generator 1301 is connected to the wireless transmitting and receiver. The clock generator 1301 generates a clock and outputs the clock to the outside of the wireless communication apparatus 1300.

Thus, it becomes possible to operate the host side and the wireless communication apparatus side in synchronization by outputting a clock generated inside the wireless communication apparatus 1300 to the outside, and operating the host side by the externally-outputted clock.

### Eighth Embodiment

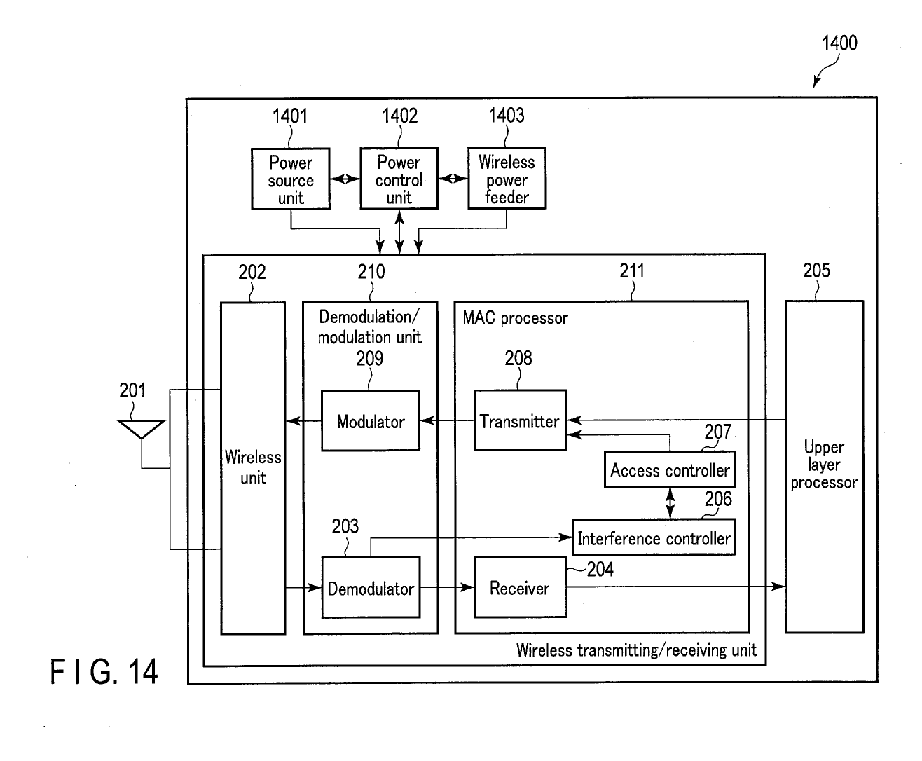

The wireless communication apparatus according to the eighth embodiment will be explained with reference to the block diagram of FIG. 14.

The wireless communication apparatus 1400 according to the eighth embodiment includes a power source unit 1401, a power controller 1402, and a wireless power feeder 1403, in addition to the wireless communication apparatus 101 shown in FIG. 2. The power controller 1402 is connected to the power source unit 1401 and the wireless power feeder 1403, and selects a power source to be supplied to the wireless communication apparatus 1400. Such a structure can realize control of power sources and low-power consumption operation.

### Ninth Embodiment

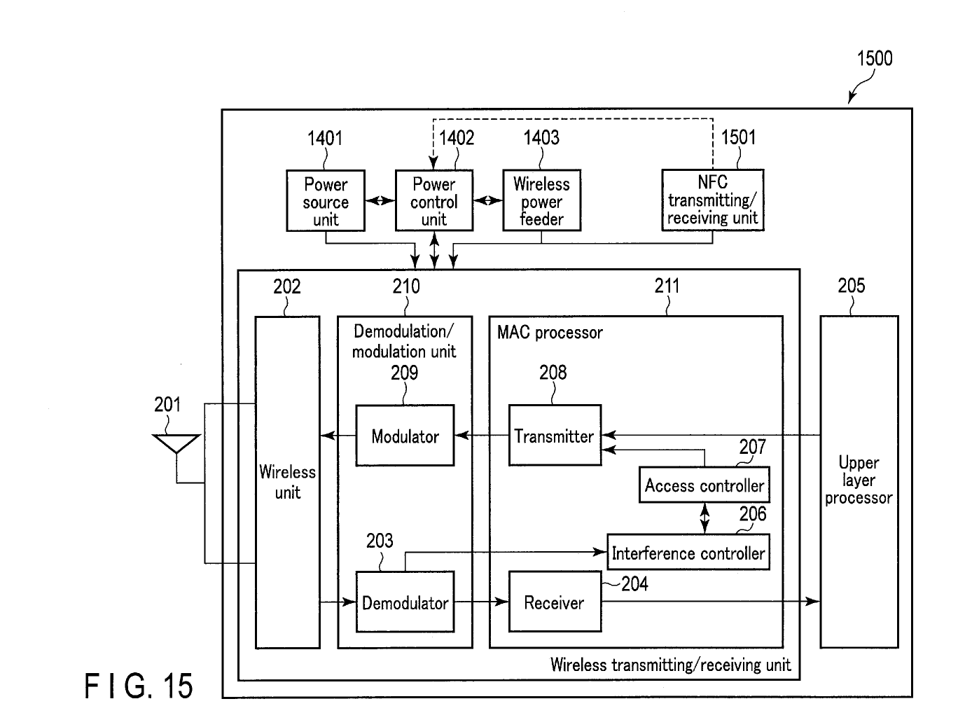

The wireless communication apparatus according to the ninth embodiment will be explained with reference to the block diagram of FIG. 15.

The wireless communication apparatus 1500 according to the ninth embodiment includes a near field communications (NFC) transmitting and receiving unit 1501 which is connected to the power controller 1402 and the demodulation/modulation unit 210, in addition to the wireless communication apparatus 1400 shown in FIG. 14. The NFC transmitting and receiving unit 1501 may be provided inside the upper layer processor 205, or may exist independently.

This structure can facilitate an authentication processing and decrease energy consumption during waiting mode by controlling the power source by using a signal received in the NFC transmitting and receiving unit 1501 as a trigger.

### Tenth Embodiment

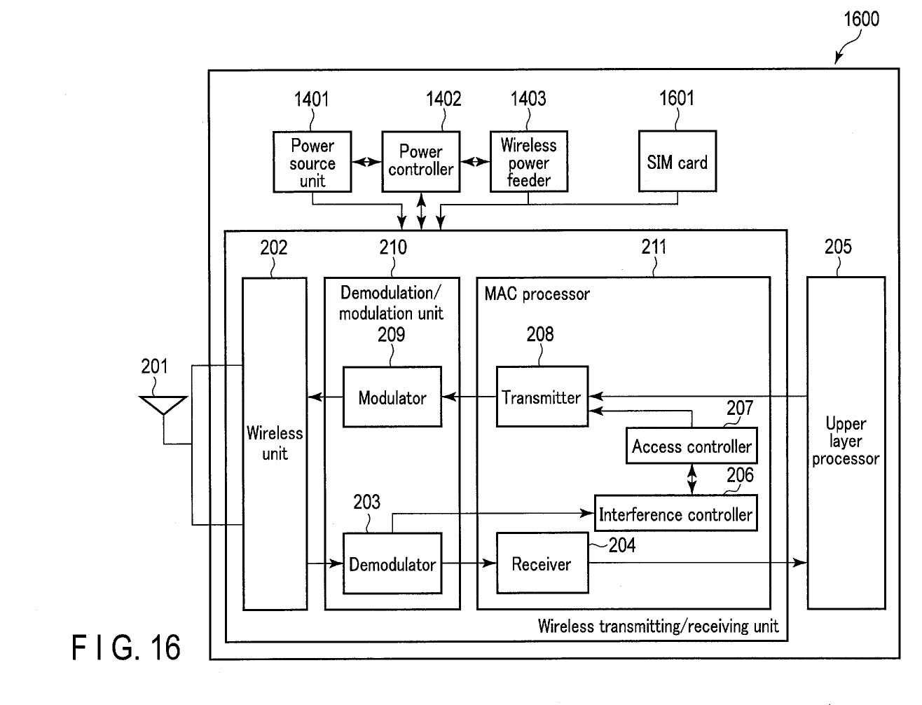

The wireless communication apparatus according to the tenth embodiment will be explained with reference to the block diagram of FIG. 16.

The wireless communication apparatus 1600 according to the tenth embodiment includes a SIM card 1601 in addition to the wireless communication apparatus 1000 shown in FIG. 14. The SIM card 1601 is connected to the demodulation/modulation unit 210. The SIM card 1601 may be provided inside the upper layer processor 205, or may exist independently.

Thus, the wireless communication apparatus including the SIM card 1601 can facilitate an authentication process.

### Eleventh Embodiment

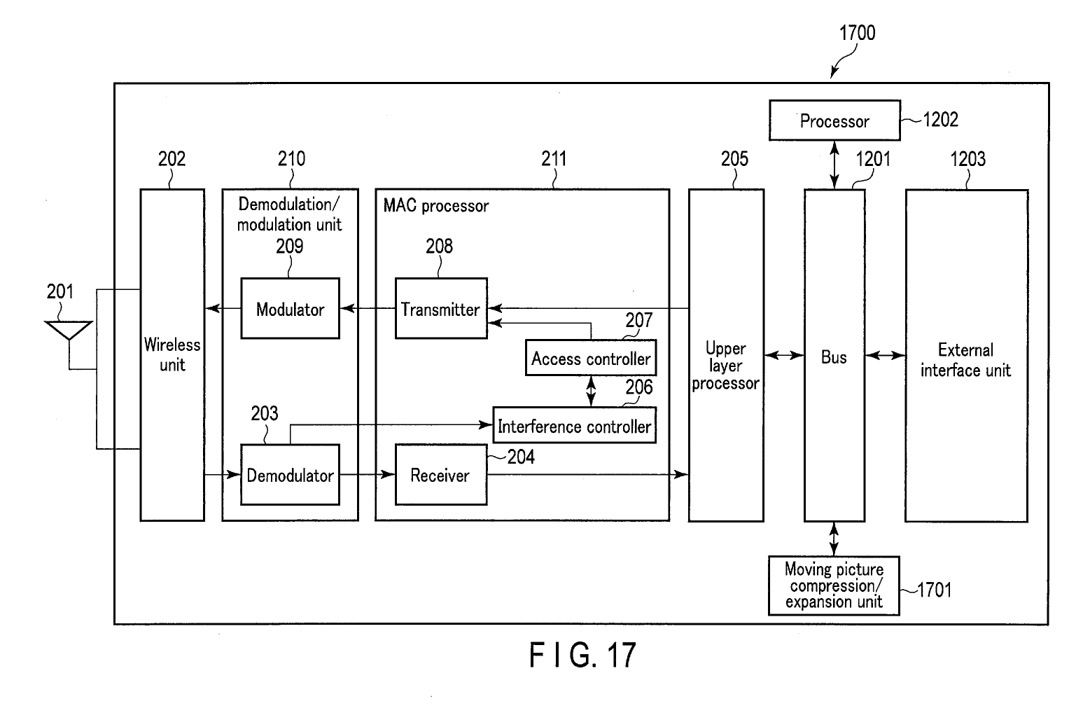

The wireless communication apparatus according to the eleventh embodiment will be explained with reference to the block diagram of FIG. 17.

The wireless communication apparatus 1700 according to the eleventh embodiment includes a moving picture compression/expansion unit 1701 in addition to the wireless communication apparatus 1200 shown in FIG. 12. The moving picture compression/expansion unit 1701 is connected to the bus 1201. This structure can facilitate transmission of compressed moving pictures and expansion of received compressed moving pictures.

### Twelfth Embodiment

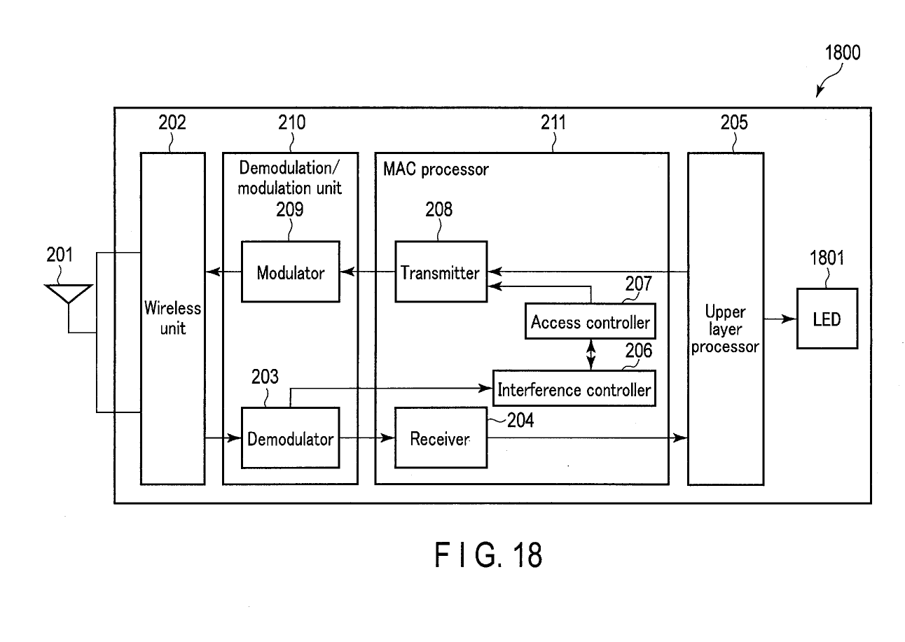

The wireless communication apparatus according to the twelfth embodiment will be explained with reference to the block diagram of FIG. 18.

The wireless communication apparatus 1800 according to the twelfth embodiment includes an LED 1801 in addition to the wireless communication apparatus 101 shown in FIG. 2. The LED 1801 is connected to the upper layer processor 205, for example. With this structure, notification of the operational status of the wireless communication apparatus can be easily made to a user.

### Thirteenth Embodiment

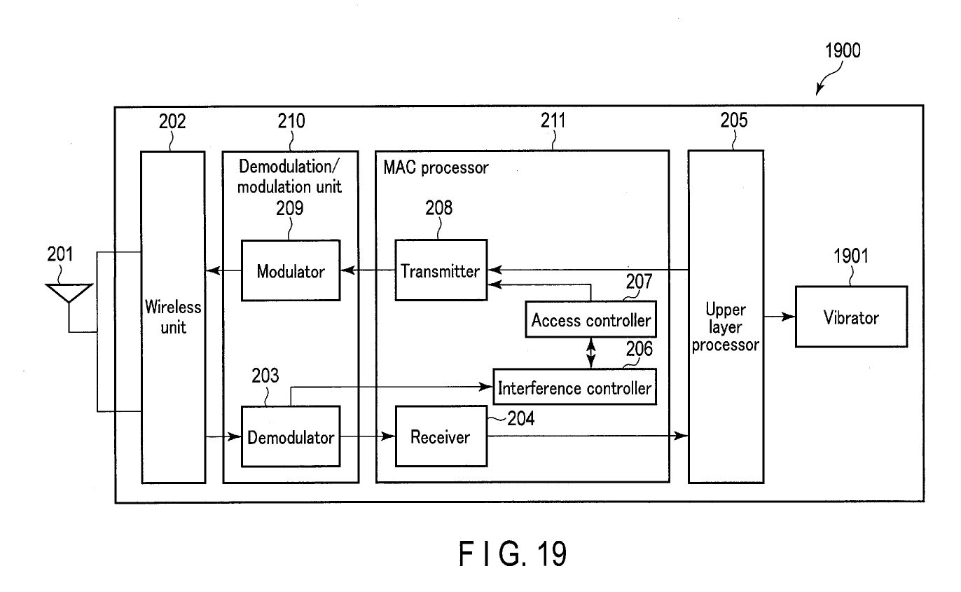

The wireless communication apparatus according to the thirteenth embodiment will be explained with reference to the block diagram of FIG. 19.

The wireless communication apparatus 1900 according to the thirteenth embodiment includes a vibrator 1901 in addition to the wireless communication apparatus 101 shown in FIG. 2. The vibrator 1901 is connected to the upper layer processor 205, for example. With this structure, notification of the operational state of the wireless communication apparatus can be easily made to a user.

### Fourteenth Embodiment

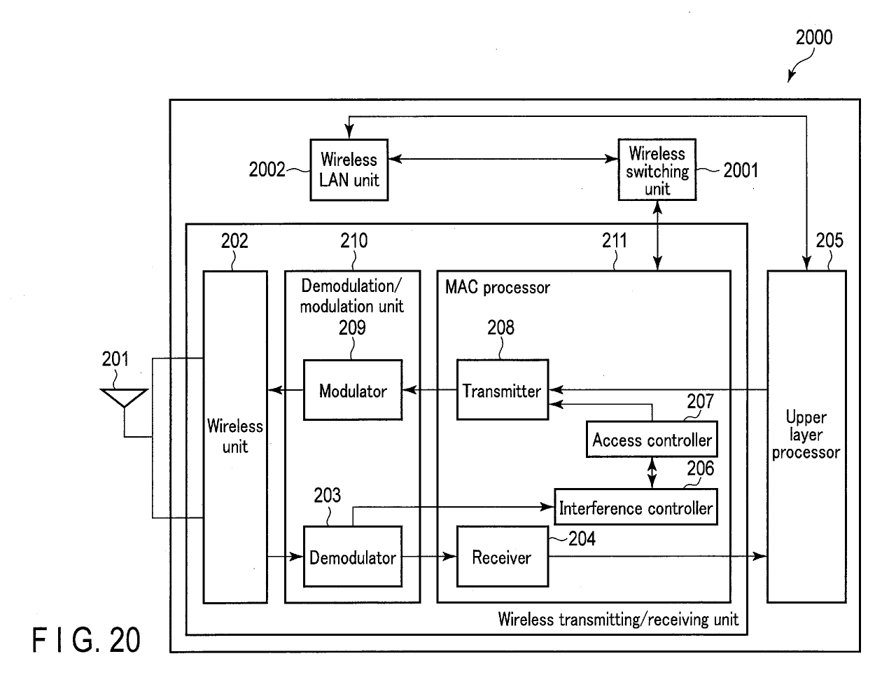

The wireless communication apparatus according to the fourteenth embodiment will be explained with reference to the block diagram of FIG. 20.

The wireless communication apparatus 2000 according to the fourteenth embodiment includes a wireless switching unit 2001 and a wireless LAN unit 2002, in addition to the wireless communication apparatus 101 shown in FIG. 2.

The wireless switching unit 2001 is connected to the wireless transmitting and receiver. Although it is possible to use a plurality of channels in the millimeter-wave band assumed in the above-described wireless communication, a communication may be switched to a wireless LAN communication if there is significant interference with the other systems in any of the channels and a desired transmission or reception cannot be achieved.

The frequency band used at the wireless LAN unit 2002 may be a frequency band IEEE802.11a,b,g which is different from a frequency band used in the above-described wireless communication, or may be 802.11ad which adopts the frequency band used in the above-described communication. Furthermore, the wireless LAN unit 2002 may include an antenna for transmission and reception, or may share an antenna when the same frequency band is used as the above-described communication.

The wireless LAN unit 2002 switches a frequency band in accordance with a request from the wireless switching unit 2001.

With this structure, it is possible to switch between a wireless LAN communication and a wireless communication depending on conditions.

### Fifteenth Embodiment

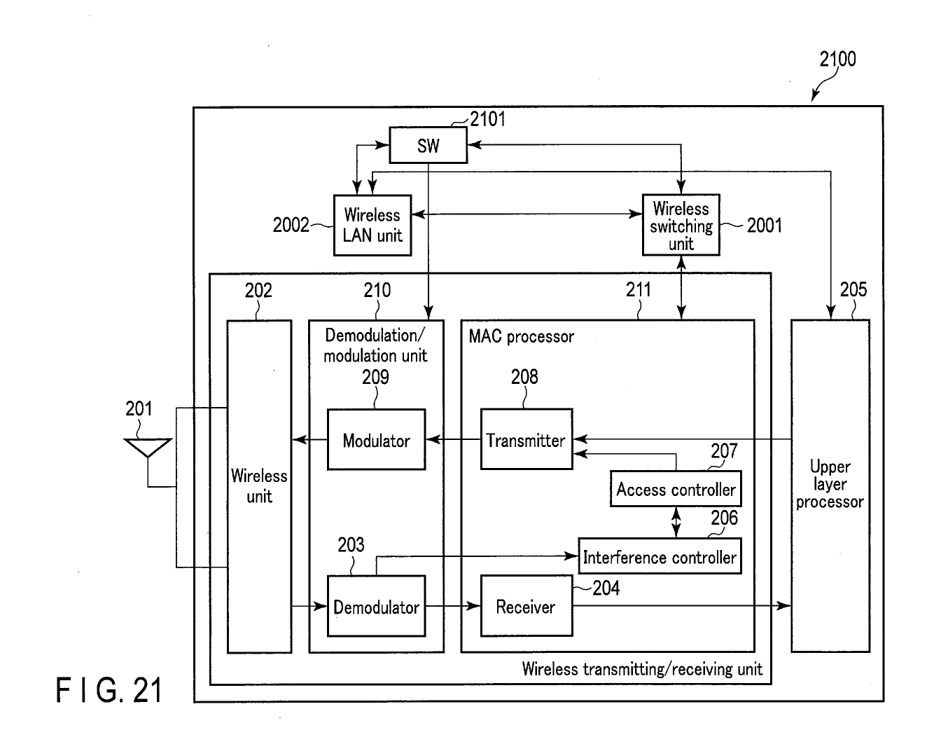

The wireless communication apparatus according to the fifteenth embodiment will be explained with reference to the block diagram of FIG. 21.

The wireless communication apparatus 2100 according to the fourteenth embodiment includes a switch (SW) 2101 in addition to the wireless communication apparatus 2000 shown in FIG. 20. The SW 2101 is connected to the wireless transmitting and receiver, the wireless LAN unit 2002, and the wireless switching unit 2001. With this structure, it is possible to switch between a wireless LAN communication and a wireless communication depending on conditions while sharing the antenna.

### Sixteenth Embodiment

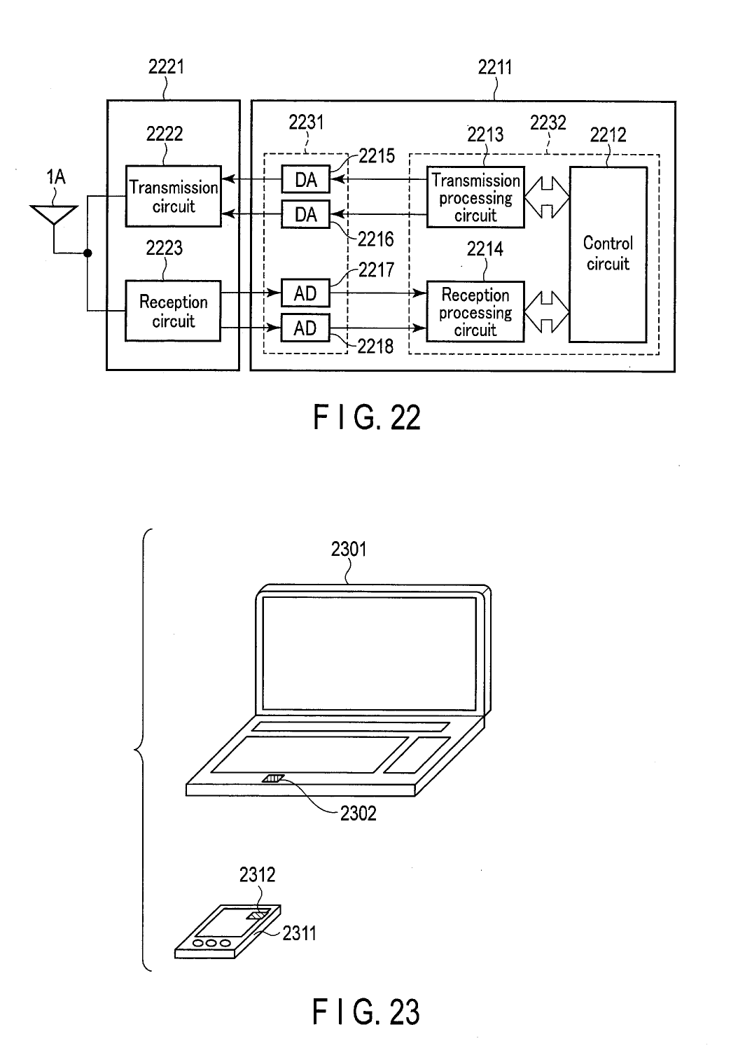

FIG. 22 illustrates a hardware configuration of a wireless communication apparatus equipped with a wireless terminal. This configuration is merely an example, and the present embodiment is not limited thereto. As the operation is basically the same as that of the above-described wireless communication apparatus, primarily the structural differences will be explained, and repetitious explanations will be omitted.

This wireless communication apparatus includes a base band unit 2211, an RF unit 2221, and an antenna 1A. The RF unit 2221 and the baseband unit 2211 may be composed of a 1-chip IC.

The baseband unit 2211 includes a control circuit (protocol stack) 2212, a transmission processing circuit 2213, a reception processing circuit 2214, and DA conversion circuits 2215 and 2216, AD conversion circuits 2217 and 2218.

The baseband unit 2211 is, for example, a baseband LSI, or a baseband IC. As another example, the baseband unit 2211 may include IC 2232 and IC 2231. The IC 2232 may include the control circuit 2212, the transmission processing circuit 2213, and the reception processing circuit 2214; and the IC 2231 may include the DA conversion circuits 2215 and 2216, and the AD conversion circuits 2217 and 2218.

The control circuit 2212 serves as, for example, a communication control apparatus which controls communications, or a controller which controls communications. The wireless communication unit may include the transmission processing circuit 2213 and the reception processing circuit 2214. The wireless communication unit may further include the DA conversion circuits 2215 and 2216, and the AD conversion circuits 2217 and 2218, in addition to the transmission processing circuit 2213 and the reception processing circuit 2214. The wireless communication unit may further include a transmission circuit 2222 and a reception circuit 2223, in addition to the DA conversion circuits 2215 and 2216, and the AD conversion circuits 2217 and 2218.

The IC 2232 may serve as a communication control apparatus which controls communications. If so, the wireless communication unit may include the transmission circuit 2222 and the reception circuit 2223. The wireless communication unit may further include the DA conversion circuits 2215 and 2216, and the AD conversion circuits 2217 and 2218, in addition to the transmission circuit 2222 and the reception circuit 2223.

The control circuit 2212 in the baseband unit 2211 includes the buffer 1101 shown in FIG. 11, and performs a process for a MAC layer, etc. The control circuit 2212 may include a clock generation unit. The transmission processing circuit 2213 performs a processing in a desired physical layer, such as a demodulation process and addition of a physical header. The DA conversion circuits 2215 and 2216 perform DA conversion on a frame processed at the transmission processing circuit 2213. In this example, the DA conversion circuit is provided in two units to perform the DA conversion in parallel; however, one DA conversion circuit will do.

The RF unit 2221 is, for example, an RF analog IC, or a high-frequency IC. The transmission circuit 2222 in the

RF unit 2221 includes a transmission filter that extracts a signal in a desired band from signals in a DA-converted frame, a mixer that up-converts a filtered signal into a radio frequency using a signal in a certain frequency supplied from an oscillator device, and a preamplifier (PA) that amplifies an up-converted signal, and so on.

The reception circuit 2223 includes an LNA (low noise amplifier) that amplifies a signal received at an antenna, a mixer that down-converts an amplified signal into a baseband signal using a signal in a certain frequency supplied from an oscillator device, and a reception filter that extracts a signal in a desired band from down-converted signals, and so on.

The AD conversion circuits 2217 and 2218 in the baseband unit 2211 performs AD conversion on an input signal from the reception circuit 2223. In this example, the AD conversion circuit is provided in two lines to perform the AD conversion in parallel; however, one AD conversion circuit will do. The reception processing circuit 2214 performs processing for a physical layer, and demodulation processing, etc. The control circuit 2212 performs a process in a MAC layer, etc. on a demodulated frame.

When the wireless terminal includes a plurality of antennas to comply with the Multi-Input Multi-Output (MIMO) scheme, the control circuit 2212 performs the processing related to MIMO. For example, the control circuit 2212 performs a transmission weight calculation process, stream separation process, and so on.

A switch that switches the antenna 1A between the transmission circuit 2222 and the reception circuit 2223 may be provided in the RF unit 2221. By the switching control, the antenna 1A is connected to the transmission circuit 2222 at the time of transmission, and to the reception circuit 2223 at the time of reception.

### Seventeenth Embodiment

FIG. 23 is a perspective view of a wireless apparatus according to the seventeenth embodiment. The wireless device shown in the upper position of FIG. 23 is a notebook PC 2301, and the wireless device shown in the lower position of FIG. 23 is a mobile terminal 2311. The notebook PC 2301 and the mobile terminal 2311 have wireless communication apparatuses 2302 and 2312, respectively. The wireless communication apparatus that has been previously explained can be used as the wireless communication apparatuses 2302 and 2312. The wireless device on which a wireless communication apparatus is installed is not limited to a notebook PC or a mobile terminal. For example, a tablet device, TV, digital camera, wearable device, etc. can also be installed on the wireless device.

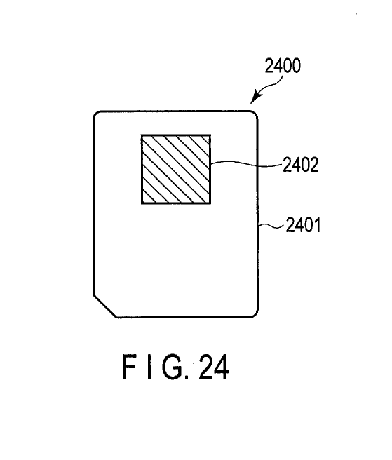

The wireless communication apparatus installed on the mobile terminal or AP can also be installed on a memory card. The example in which the wireless communication apparatus is installed on a memory card is shown in FIG. 24. A memory card 2400 includes a memory card main body 2401 and a wireless communication apparatus 2402. The memory card 2400 utilizes a wireless communication apparatus 2402 for wireless communication with external devices (e.g., a wireless terminal or an AP). Other elements that constitute the memory card 2400 (e.g., a memory, etc.) are omitted in FIG. 24.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication apparatus using a first wireless communication scheme, the apparatus comprising:
a transmitter which transmits a frame using one of a first interframe space (IFS) and a second IFS, the first IFS being shorter than a third IFS which is used in a second wireless communication scheme having a coverage area wider than a coverage area of the first wireless communication scheme, the second IFS being longer than the third IFS; and
a controller which controls IFSs so as to set, for each first period, one of the first IFS and the second IFS as an IFS used during the first period, wherein
when a channel is idle during a period corresponding to a fourth IFS after one of the IFSs is switched from the first IFS to the second IFS, and when the channel becomes busy after the period corresponding to the fourth IFS is elapsed, the controller sets the second IFS to at least one second period, the fourth IFS being an IFS before a transmission of a beacon signal used in the second wireless communication scheme, the second period being one of a plurality of first periods and being a period which includes timing for an estimated cycle of the beacon signal.

2. The apparatus according to claim 1, further comprising a receiver which receives a frame from another apparatus using the first wireless communication scheme, wherein
when a channel is idle during the period corresponding to the fourth IFS from a point of time at which a frame transmission and reception is finished in the first period which is set as the first IFS and when the channel becomes busy after the period corresponding to the fourth IFS is elapsed, the controller sets the second IFS to at least the second period.

3. The apparatus according to claim 1, wherein the first period is set at 1/n of the cycle, n being a positive even number.

4. The apparatus according to claim 1, wherein the controller sets the first IFS and the second IFS alternately for each first period.

5. The apparatus according to claim 4, wherein the controller reverses the order of the first IFS and the second IFS which are alternately set after the second period which is set as the second IFS is elapsed.

6. The apparatus according to claim 1, wherein the controller updates the estimated cycle based on timing of the busy when a channel is idle during the period corresponding to the fourth IFS and when the channel becomes busy after the period corresponding to the fourth IFS is elapsed, after the second period is set to the second IFS.

7. The apparatus according to claim 1, wherein the controller estimates a timing for transmitting the beacon signal in accordance with at least one of a first determination process to determine whether or not a continuous time of the busy is equal to a frame length of the beacon signal;
a second determination process to determine whether or not the channel is idle during a period corresponding to a fifth IFS and the channel becomes busy after a period during which the channel is idle for the period corresponding to the fourth IFS and the channel becomes busy is elapsed;
a third determination process to determine whether or not the channel is busy during a third period which is set immediately after the transmission of the beacon signal; and
a fourth determination process to determine whether or not a difference between a first power during the period in which the channel is idle for the period corresponding to the fourth I and the channel becomes busy and a second power during a different period in which the channel is busy exceeds a threshold.

8. A wireless terminal comprising:
the wireless communication apparatus according to claim 1; and
at least one antenna.

9. A memory card comprising:
the wireless communication apparatus according to claim 1; and
at least one antenna.

10. An integrated circuit comprising the wireless communication apparatus according to claim 1.

11. A wireless communication method using a first wireless communication scheme, the method comprising:
transmitting a frame using one of a first interframe space (IFS) and a second IFS, the first IFS being shorter than a third IFS which is used in a second wireless communication scheme having a coverage area wider than a coverage area of the first wireless communication scheme, the second IFS being longer than the third IFS; and
controlling IFSs so as to set, for each first period, one of the first IFS and the second IFS as an IFS used during the first period, wherein
the controlling sets the second IFS to at least a second period when a channel is idle during a period corresponding to a fourth IFS after one of the IFSs is switched from the first IFS to the second IFS, and when the channel becomes busy after the period corresponding to the fourth IFS is elapsed, the fourth IFS being an IFS before a transmission of a beacon signal used in the second wireless communication scheme, the second period being one of a plurality of first periods and being a period which includes timing for an estimated cycle of the beacon signal.

12. The method according to claim 11, further comprising receiving a frame from another apparatus using the first wireless communication scheme, wherein the controlling sets the second IFS to at least the second period when a channel is idle during the period corresponding to the fourth IFS from a point of time at which a frame transmission and reception is finished in the first period which is set as the first IFS and when the channel becomes busy after the period corresponding to the fourth IFS is elapsed.

13. The method according to claim 11, wherein the first period is set at 1/n of the cycle, n being a positive even number.

14. The method according to claim 11, wherein the controlling sets the first IFS and the second IFS alternately for each first period.

15. The method according to claim 14, wherein the controlling reverses the order of the first IFS and the second IFS which are alternately set after the second period which is set as the second IFS is elapsed.

16. The method according to claim 11, wherein further comprising updating the estimated cycle based on timing of the busy when a channel is idle during the period corresponding to the fourth IFS and when the channel becomes busy after the period corresponding to the fourth IFS is elapsed, after the second period is set to the second IFS.

17. The method according to claim 11, wherein further comprising estimating a timing for transmitting the beacon signal in accordance with at least one of
a first determination process to determine whether or not a continuous time of the busy is equal to a frame length of the beacon signal;
a second determination process to determine whether or not the channel is idle during a period corresponding to a fifth IFS and the channel becomes busy after a period during which the channel is idle for the period corresponding to the fourth IFS and the channel becomes busy is elapsed;
a third determination process to determine whether or not the channel is busy during a third period which is set immediately after the transmission of the beacon signal; and
a fourth determination process to determine whether or not a difference between a first power during the period in which the channel is idle for the period corresponding to the fourth I and the channel becomes busy and a second power during a different period in which the channel is busy exceeds a threshold.
